(19) United States
(12) Patent Application Publication
(10) Pub. No.: US 2012/0060376 A1
(43) Pub. Date: Mar. 15, 2012

(54) PEX CLAMP RING REMOVAL TOOL

(75) Inventor: Jeffrey Alexander Polofsky, Matthews, NC (US)

(73) Assignee: CONBRACO INDUSTRIES, INC., Pageland, SC (US)

(21) Appl. No.: 12/880,374

(22) Filed: Sep. 13, 2010

(51) Int. Cl. B26B 17/00

(52) U.S. Cl. 30/177

(57) ABSTRACT

A cross-linked polyethylene (PEX) tubing clamp ring removal tool including first and second handles pivotally connected, first and second jaw members pivotally connected to the first and second handles, respectively, a coarse adjuster slidably carried on the first handle including a stepped member defining first and second seating surfaces of different heights, the stepped member slidable relative to the first handle in a direction generally parallel to a longitudinal axis of the first handle, and a fine adjuster carried on the second handle positioned between the first and second handles and in alignment with the stepped member.

### TECHNICAL FIELD AND BACKGROUND OF THE INVENTION

1. Field of the Invention

The present invention relates generally to the field of tools configured for use with cross-linked polyethylene (“PEX”) tubing and accessories, and more particularly, to a tool for removing an installed PEX clamp ring from around PEX tubing to release an installed fitting, the tool having ring cutting size adjustment including a coarse adjuster carried on a first handle in alignment and cooperating with a fine adjuster carried on a second handle, the coarse adjuster being slidable in a direction parallel with its respective handle to move seating surfaces of varying height into alignment with the fine adjuster to control the distance between jaws of the tool.

2. Background of the Invention

Known to those skilled in the art, PEX tubing is commonly used in plumbing applications as an alternative to polyvinylchloride (“PVC”) and copper pipe. Uses of PEX tubing include general plumbing applications, hydronic radiant heating systems, water piping and insulation systems, and the general transportation of fluids and slurries, among other uses. PEX tubing is commonly terminated in a fitting requiring a clamp or clamp ring fastened over the tubing for ensuring sealing engagement of the tubing and fitting.

In certain situations it is desired to free an installed fitting from within an end of PEX tubing, such as to remove the fitting for reuse. Removal of an installed fitting is typically accomplished by cutting the pipe close to the fitting, inserting a jaw of the tool inside the fitting, and compressing the handles to force a cutter through the crimp ring. The process then includes repositioning the cutter to the other side of the crimp ring and compressing the handles to force the crimp ring open. The PEX ring may then be removed from the pipe and the tool further used to make radial cuts around the tubing to release the fitting.

While tools are known for removing PEX clamp rings, conventional tools include ring cutting size adjustment mechanisms that are either difficult to use or do not provide a clear indication of the cutting size setting to the user. Thus, what is desired is a PEX clamp ring removal tool that overcomes the disadvantages of the prior art tool designs by providing simple adjustment for setting ring cutting sizes without the need for tools, providing both coarse and fine adjustment, and providing a clear indication to the user of the cutting size.

### BRIEF SUMMARY OF THE INVENTION

In one aspect, an adjustable PEX clamp ring removal tool is provided for removing a clamp from around PEX tubing or “pipe”, for example to remove an installed fitting from the tubing for reuse.

In another aspect, the tool includes first and second handles operationally connected to first and second jaw members, respectively, wherein opening and closing of the handles causes simultaneous opening and closing of the jaw members, however to a lesser degree.

In another aspect, the first jaw member terminates in a projection having a generally circular cross-section and diametrically opposed chamfered sides so as to be removably received within a fitting when cutting the clamp ring, and the second jaw member terminates in a cutting blade.

In another aspect, the first and second handles are interconnected at one end at a common pivot, the first and second jaw members are each pivotally connected about one end to their respective handle, and the first and second jaw members are independently pivotally interconnected through a common jaw connector, wherein closing of the handles causes simultaneous closing of the jaw members.

In another aspect, the tool includes a coarse adjuster carried on the first handle in alignment and cooperating with a fine adjuster carried on the second handle to control the amount of travel between the first and second handles and consequentially the distance between the free ends of the first and second jaw members.

In another aspect, the coarse adjuster presents seating surfaces of first and second heights in alignment with the fine adjuster, wherein seating surface height is selected by sliding the coarse adjuster in a direction generally parallel with the longitudinal axis of the first handle.

In another aspect, the first handle defines aligned, elongate slots through opposing sides thereof slidably carrying a stepped body therebetween within a channel defined by the first handle, wherein the stepped body is attached to gripping members positioned on opposing sides of the first handle attached to the stepped member through the slots for sliding the stepped body with respect to the first handle.

In another aspect, the fine adjuster includes a threaded post carried on the second handle and positioned intermediate the first and second handles that can be selectively advanced into and withdrawn from the second handle to control the amount of travel between the first and second handles, and consequentially the first and second jaw members.

In another aspect, advancing the post in the second handle in a direction away from the first handle brings the first and second jaw members closer together when the handles are compressed (i.e. “brought together”).

In another aspect, the stepped body includes first and second seating surfaces providing first and second coarse adjustment positions, respectively.

To achieve the foregoing and other aspects and advantages, a PEX clamp ring removal tool is provided herein including first and second handles pivotally connected, first and second jaw members pivotally connected to the first and second handles, respectively, and independently pivotally interconnected through a common jaw connector, the first jaw member defining a projection at its free end and the second jaw member defining a cutting blade at its free end, a coarse adjuster slidably carried on the first handle and including first and second seating surfaces defining first and second seating positions having different heights, respectively, the coarse adjuster slidable relative to the first handle in a direction generally parallel to a longitudinal axis of the first handle, and a fine adjuster carried on the second handle positioned between the first and second handles and in alignment with the coarse adjuster, the fine adjuster comprising a post threadably engaged with the second handle.

In a further embodiment, the coarse adjuster includes a stepped body slidably carried within a channel defined within the first handle, and wherein the first and second seating surfaces face the second handle.

In a further embodiment, the first handle defines aligned first and second elongate slots therethrough oriented parallel to the longitudinal axis of the first handle.

In a further embodiment, the coarse adjuster further includes first and second gripping members positioned on opposing sides of the handle and attached to the stepped body through the first and second elongate slots, respectively.

In a further embodiment, the coarse adjuster is moveable relative to the first and second elongate slots to selectively position one of the first and second seating surfaces in alignment with the post of the fine adjuster.

In a further embodiment, a free end of the post seats upon one of the first and second seating surfaces when the first and second handles are fully compressed.

In a further embodiment, the post threadably engages a sidewall of the second handle such that advancing the post within the sidewall moves a free end of the post apart from the first handle.

In a further embodiment, the projection has a generally circular cross-sectional profile having diametrically opposed chamfered sides.

In a further embodiment, the first seating position corresponds to a ½″ clamp ring cutting size, and the second seating position corresponds to a ¾″ clamp ring cutting size.

According to another embodiment of the invention, a cross-linked polyethylene (PEX) tubing clamp ring removal tool is provided including first and second handles pivotally connected, first and second jaw members pivotally connected to the first and second handles, respectively, and independently pivotally interconnected through a common jaw connector, a coarse adjuster slidably carried on the first handle, the coarse adjuster including a stepped member defining first and second seating surfaces of different heights, the stepped member slidable relative to the first handle in a direction generally parallel to a longitudinal axis of the first handle, and a fine adjuster carried on the second handle positioned between the first and second handles and in alignment with the stepped member.

In a further embodiment, the first handle defines an elongate slot therethrough oriented generally parallel to the longitudinal axis of the first handle, and wherein the coarse adjuster further comprises a gripping member attached to the stepped member through the elongate slot for moving the stepped member relative to the elongate slot to select between the first and second seating surfaces.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

These and other features, aspects and advantages of the present invention are better understood when the following detailed description of the invention is read with reference to the accompanying drawings, in which:

FIG. 1 is a plan view of the PEX clamp ring removal tool shown in the open configuration and with the coarse adjuster in a first position;

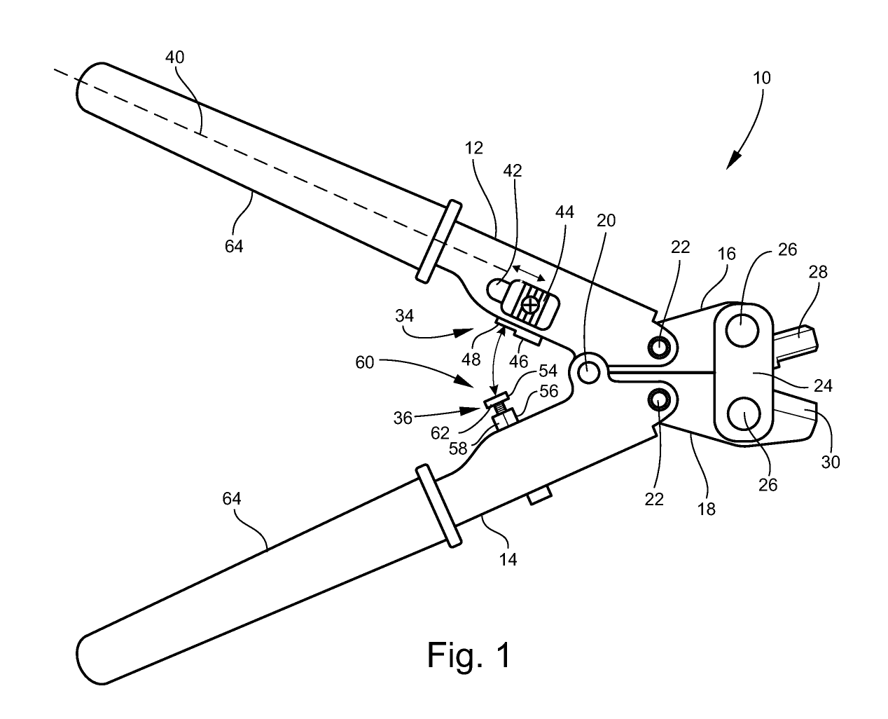

FIG. 2 is a plan view of the PEX clamp ring removal tool of FIG. 1 shown in the closed configuration;

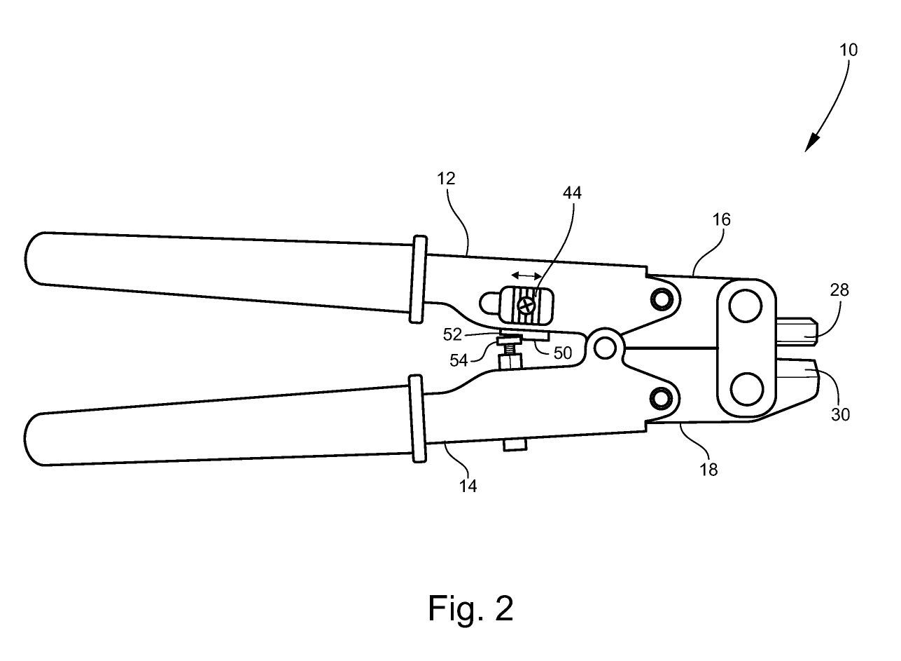

FIG. 3 is a plan view of the PEX clamp ring removal tool of FIG. 1 shown in the closed configuration with the coarse adjuster in a second position; and

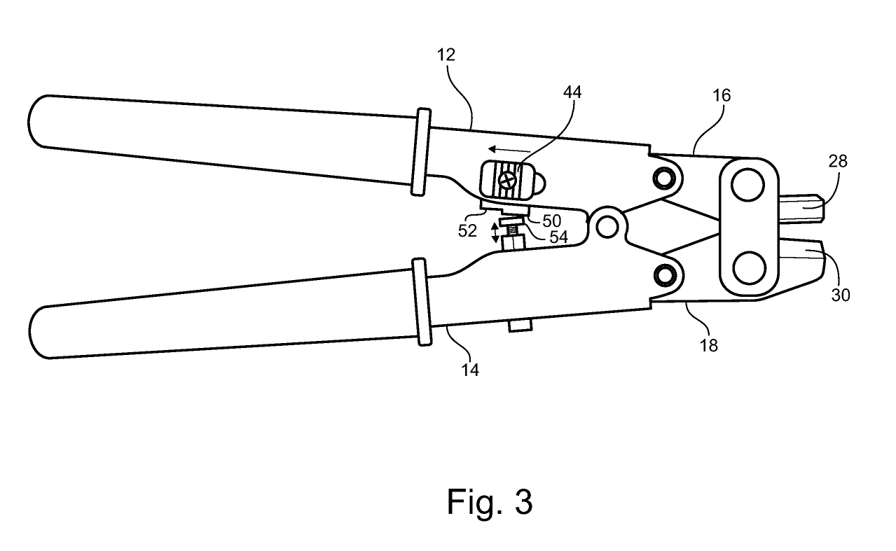

FIG. 4 is a detailed perspective view of the PEX clamp ring removal tool of FIG. 1 shown in the open configuration.

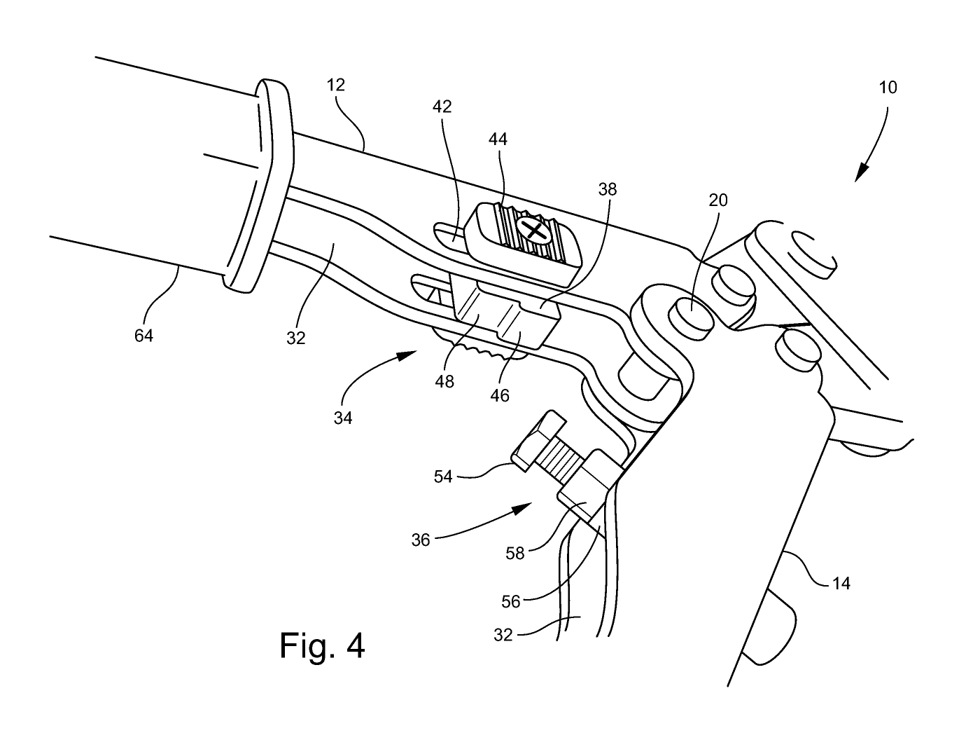

### DETAILED DESCRIPTION OF THE INVENTION

The present invention will now be described more fully hereinafter with reference to the accompanying figures in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

Referring to the figures, an adjustable PEX clamp ring removal tool is shown generally at reference numeral 10. Ring removal tool 10 generally includes first and second handles 12, 14 pivotally connected, and first and second jaw members 16, 18 pivotally connected at one end to first and second handles 12, 14, respectively, wherein opening and closing of handles 12, 14 causes simultaneous opening and closing of jaw members 16, 18, however to a lesser degree. As used herein, the term “closing” the handles means bringing the handles together and is also referred to herein as “compressing” the handles, and the term “opening” the handles means pulling the handles apart.

First and second handles 12, 14 are connected about a first end at pivot 20. First and second jaw members 16, 18 are pivotally connected at a first end to their respective handle at pivot 22, and are further independently pivotally interconnected through a common jaw connector 24 positioned about midway along the length of first and second jaw members 16, 18. Thus, first and second jaw members 16, 18 are each pivotally connected to jaw connector 24 at pivot 26 to allow them to pivot relative thereto in response to movement of the handles. Jaw connector 24, with one jaw connector preferably provided on each “side” of tool 10, maintains first and second jaw members 16, 18 together.

First jaw member 16 terminates at its free end in a projection 28 that is received within the fitting while the clamp ring is being cut. In an exemplary embodiment, projection 28 has a generally circular cross-section with diametrically opposed chamfered sides to allow the projection to be easily withdrawn from the interior of the cylindrical fitting after the clamp ring is cut. It is envisioned that alternative geometries may be provided for the cross-section of projection 28, such as corresponding to the interior geometry of a fitting. Second jaw member 18 terminates in cutting blade 30, which faces projection 28.

To remove a clamp ring, projection 28 is received within the interior of the fitting installed on a cut section of PEX tubing. Handles 12, 14 are compressed causing cutting blade 30 to cut the clamp ring. When in the fully closed configuration, projection 28 and cutting blade 30 preferably do not physically contact one another, thus the purposeful space provided therebetween is able to accommodate the wall of the fitting and prevent cutting blade 30 from damaging the fitting wall, allowing the fitting to be reused.

Each of first and second handles 12, 14 generally define an elongate channel 32 that houses its respective adjuster. Specifically, first handle 12 slidably carries coarse adjuster 34 within its channel, and second handle 14 carries fine adjuster 36 within its channel. The operational portions of coarse adjuster 34 and fine adjuster 36 face one other and are in alignment between first and second handles 12, 14.

Coarse adjuster 34 generally includes stepped member 38 slidably carried within channel 32, which slides generally parallel to longitudinal axis 40 of first handle 12 to select between clamp ring cutting sizes. As shown, first handle 12 defines aligned, elongate slots 42 therethrough through which gripping members 44 are attached to stepped member 38. Elongate slots 42 are oriented generally parallel to longitudinal axis 40. Gripping members 44 are provided on each “side” of tool 10 for manipulating (i.e. “sliding”) stepped member 38 relative to slots 42 to select between seating surfaces of varying heights. For example, stepped member 38 as shown includes first and second seating surfaces 46, 48 facing in the direction of fine adjuster 36, with each defining a seating surface 50, 52, respectively, for seating the fine adjuster when the handles are compressed. A seating surface is chosen by sliding stepped member 38 into alignment with fine adjuster 36 by manipulating stepped member 38 by way of gripping member 44.

In an exemplary embodiment, first seating surface 46 corresponds to a ½″ PEX clamp ring cutting size and second seating surface 48 corresponds to a ¾″ PEX clamp ring cutting size. Thus, first seating surface 46 extends a greater distance than second seating surface 48 from first handle 12 in the direction toward second handle 14. It is envisioned that alternative step arrangements and varying heights may be provided by modifying stepped member 38 to accommodate other ring cutting sizes.

Fine adjuster 36 generally includes threaded post 54 threadable engaged in second handle 14, such as in internally threaded barrel 56 maintained in channel 32 as shown. Lock nut 58 threaded on post 54 may be advanced into engagement with barrel 56 when post 54 is in its desired advancement within barrel 56 to maintain the position of free end 60 of post 54 when set to where desired. As shown, free end 60 of post 54 terminates in hexagonal head 62 to facilitate turning with a wrench. Head 62 is aligned with and seats against either the first or second selected seating surface 46, 48 of stepped member 38 when handles 12, 14 are fully compressed to stop closing movement therebetween and consequentially limit closing movement of jaw members 16, 18 to maintain a space therebetween.

Thus, tool 10 includes both coarse and fine adjustment for controlling the degree of closing of the handles, with coarse adjustment provided through the slidability of stepped member 38 and fine adjustment provided through the turning of post 54 relative to second handle 14. Tool 10 may further include indicia printed, stamped or otherwise carried thereon for clearly indicating to the user the position of stepped member 38 and the ring cutting size selected. Tool 10 further includes grips 64 for comfort and insulation.

While a PEX clamp ring removal tool has been described herein with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A clamp ring removal tool, comprising:
first and second handles pivotally connected;
first and second jaw members pivotally connected to the first and second handles, respectively, and independently pivotally interconnected through a common jaw connector, the first jaw member defining a projection at its free end and the second jaw member defining a cutting blade at its free end;
a coarse adjuster slidably carried on the first handle and including first and second seating surfaces defining first and second seating positions having different heights, respectively, the coarse adjuster slidable relative to the first handle in a direction generally parallel to a longitudinal axis of the first handle; and
a fine adjuster carried on the second handle positioned between the first and second handles and in alignment with the coarse adjuster, the fine adjuster comprising a post threadably engaged with the second handle.

2. The clamp ring removal tool according to claim 1, wherein the coarse adjuster comprises a stepped body slidably carried within a channel defined within the first handle, and wherein the first and second seating surfaces face the second handle.

3. The clamp ring removal tool according to claim 2, wherein the first handle defines aligned first and second elongate slots therethrough oriented parallel to the longitudinal axis of the first handle.

4. The clamp ring removal tool according to claim 3, wherein the coarse adjuster further comprises first and second gripping members positioned on opposing sides of the handle and attached to the stepped body through the first and second elongate slots, respectively.

5. The clamp ring removal tool according to claim 4, wherein the coarse adjuster is moveable relative to the first and second elongate slots to selectively position one of the first and second seating surfaces in alignment with the post of the fine adjuster.

6. The clamp ring removal tool according to claim 1, wherein a free end of the post seats upon one of the first and second seating surfaces when the first and second handles are fully compressed.

7. The clamp ring removal tool according to claim 1, wherein the post threadably engages a sidewall of the second handle such that advancing the post within the sidewall moves a free end of the post apart from the first handle.

8. The clamp ring removal tool according to claim 1, wherein the projection has a generally circular cross-sectional profile having diametrically opposed chamfered sides.

9. The clamp ring removal tool according to claim 1, wherein the first seating position corresponds to ½″ clamp ring cutting size, and the second seating position corresponds to a ¾″ clamp ring cutting size.

10. A cross-linked polyethylene (PEX) tubing clamp ring removal tool, comprising:
first and second handles pivotally connected;
first and second jaw members pivotally connected to the first and second handles, respectively, and independently pivotally interconnected through a common jaw connector;
a coarse adjuster slidably carried on the first handle, the coarse adjuster comprising a stepped member defining first and second seating surfaces of different heights, the stepped member slidable relative to the first handle in a direction generally parallel to a longitudinal axis of the first handle; and
a fine adjuster carried on the second handle positioned between the first and second handles and in alignment with the stepped member.

11. The clamp ring removal tool according to claim 10, wherein the first handle defines an elongate slot therethrough oriented generally parallel to the longitudinal axis of the first handle, and wherein the coarse adjuster further comprises a gripping member attached to the stepped member through the elongate slot for moving the stepped member relative to the elongate slot to select between the first and second seating surfaces.

12. The clamp ring removal tool according to claim 11, wherein the stepped member is moveable relative to the elongate slot to selectively position one of the first and second seating surfaces in alignment with the fine adjuster.

13. The clamp ring removal tool according to claim 10, wherein the fine adjuster comprises a post threadably engaged in the second handle and having a free end positioned between the first and second handles in alignment with the stepped member.

14. The clamp ring removal tool according to claim 13, wherein the free end of the post seats upon one of the first and second seating surfaces when the first and second handles are fully compressed.

15. The clamp ring removal tool according to claim 13, wherein the post threadably engages a sidewall of the second handle such that advancing the post within the sidewall moves the free end of the post apart from the first handle.

16. The clamp ring removal tool according to claim 10, wherein the first jaw member defines a projection at its free end having a generally circular cross-sectional profile having diametrically opposed chamfered sides, and the second jaw member defines a cutting blade.

17. The clamp ring removal tool according to claim 10, wherein the first seating position corresponds to a ½″ clamp ring cutting size, and the second seating position corresponds to a ¾″ clamp ring cutting size.
